(19) United States
(12) Patent Application Publication
(10) Pub. No.: US 2011/0181183 A1
(43) Pub. Date: Jul. 28, 2011

(54) LED LAMP WITH HEAT DISSIPATION MEMBER

(75) Inventor: Young Ho YOO, Seoul (KR)

(73) Assignees: Young Ho Yoo, Seoul (KR); FAWOO TECHNOLOGY CO., LTD., Bucheon-si (KR)

(21) Appl. No.: 13/079,264

(22) Filed: Apr. 4, 2011

(30) Foreign Application Priority Data
Oct. 30, 2009 (KR) 10-2009-0104139
Nov. 4, 2009 (KR) 10-2009-0105847
Dec. 18, 2009 (KR) 10-2009-0126522

(51) Int. Cl. H01K 1/62

(52) U.S. Cl. 315/35

(57) ABSTRACT

An LED lamp includes at least one LED mounted on a PCB, a floodlight cover, a power source base, and a heat dissipation transfer member. The floodlight cover transmits light from the at least one LED and has an inner face facing an upper inner space of the LED lamp. The power source base is coupled to a terminal at one end of the power source base and is coupled to the floodlight cover at the other end of the power source base. The power source base is made of an insulation material and forms a surface layer of the LED lamp from the one end of the power source base to the other end of the power source base. The power source base has an inner face facing a lower inner space of the LED lamp. The heat dissipation transfer member has a heat sink being in contact with the PCB, and a main body formed along with an entire surface of at least one of the inner face of the power source base and the inner face of the floodlight cover. The main body of the heat dissipation transfer member is faced with the entire surface without any space therebetween.

### CROSS-REFERENCE TO RELATED APPLICATIONS

This application is based upon and claims the priorities from prior Korean patent Application No. 2009-0104139 filed on Oct. 30, 2009, prior Korean patent Application No. 2009-0105847 filed on Nov. 4, 2009, prior Korean patent Application No. 2009-0126522 filed on Dec. 18, 2009, and is a Continuation application based on, and claims priority from, U.S. application Ser. No. 12/886,227, filed Sep. 20, 2010, the disclosure of which is hereby incorporated by reference herein in its entirety.

### BACKGROUND OF THE INVENTION

1. Field of the Invention

The present invention relates to an LED lamp in which, because the lamp has therein a heat dissipation transfer member and the power source base thereof is made of materials including polycarbonate, etc. with a high emission rate of radiation so as to enhance its surface heat dissipation constant, the power source base has sufficient heat dissipation performance and, thus, a separate insulation circuit is not necessary, thereby improving reliability and productivity of the lamp as well as reducing the cost of manufacturing.

The present invention relates to an LED lamp that provides uniform high-quality illuminance without glare by employing a light guiding type floodlight cover.

The present invention relates to an LED lamp that improves the heat dissipation performance markedly with a stack effect attained by employing a ventilation channel for heat dissipation.

The present invention relates to an LED lamp that includes a power control unit integrating an optical source part in which both the power control unit and LEDs (optical source) are mounted onto one PCB, hence, reducing the cost of PCB equipment by about a half and raising the productivity of the lamp remarkably.

2. Description of Related Arts

Since LED (Light Emitting Diode) has special merits such as smaller size and longer life than conventional light sources and high energy efficiency due to the direct transformation of electrical energy to optical energy, it has been studied in various aspects.

An LED lamp is particularly desirable in that it is compatible with existing lamps such as bulb type lamps and halogen lamps.

In an LED lamp, LED is generally installed within a closed space formed by the power source base and the floodlight cover.

Accordingly, if heat is generated while the lamp is on, the generated heat does not dissipate properly and, as a result, its illuminance deteriorates rapidly and its lifetime is also shortened remarkably.

In such an LED lamp, heat dissipates through the power source base being in contact with the PCB on which the LED is mounted, but heat from the LED is transferred to the power source base only through a limited area in which the PCB and one end of the power source base contact each other.

Moreover, since the power source base must be insulated, it is made of an insulation material. If the power source base is made of metal, which does not have an insulation property, a separate insulation circuit must be included in the LED driving circuit in order to improve heat dissipation efficiency.

In the latter case,

the separate insulation circuit including primary and secondary coils must be included in the LED driving circuit, and the addition of the electronic devices makes the configuration of the LED driving circuit complicated and increases the manufacturing cost of the lamp.

Furthermore, in case aluminum with high thermal conductivity is employed as the material of the base, the emission rate of radiation, which determines the surface heat dissipation constant, is very low and therefore an insulation circuit must be included. In that case, heat dissipation efficiency is relatively low compared to the cost of manufacturing (see Table 1).

On the other hand, in case the power source base is made of an insulation material, the insulation material has low thermal conductivity and moreover, as mentioned above, heat is transferred to the power source base only through the limited area in which the PCB and one end of the power source base contact each other and, as a result, heat transfer between the power source base and the PCB as well as heat diffusion and dissipation through the entire outer surface of the power source base is delayed. Consequently, the heat dissipation performance of the lamp becomes poor, and this results in low illuminance and short lifetime.

What is more, light from the LED runs straight and concentrate. These properties make a large difference in illuminance between the center directly under the lamp and its peripheral region, and lower the quality of illumination considerably.

That is, in an incandescent lamp, the difference in illuminance between the center and the peripheral region is small, whereas in this prior art LED lamp, light from LED focuses on the central region and therefore the center is excessively bright and glaring but the peripheral region is much darker.

In the conventional technology, the floodlight cover is coated with a light diffusion agent or multiple filters are formed on the cover in order to avoid glaring. However, those approaches lower the illuminance.

Moreover, as LED is driven by a low DC voltage, a high voltage or AC voltage can damage it. Therefore, an LED lamp employing general LED includes a DC voltage conversion circuit to transform external power supply in the power control unit for driving the LED.

Accordingly, a LED lamp is mounted with two separate PCBs, one for the optical source onto which the LED is fixed and the other for the power control unit on which electrical devices forming the power control unit are mounted, are required. Then, in order to interconnect the two PCBs electrically, a wire and a connector are required, which increases the cost of materials. Furthermore, there should be a plurality of assembling steps, resulting in the increase of the manufacturing cost.

Moreover, as the LED optical source and the power control unit are disposed as two discrete units, thereby forming complex configuration, defects may occur at the connecting process for electrically connecting the two units and productivity goes down.

### SUMMARY OF THE INVENTION

### Problems to be Solved

The present invention was made in consideration of the foregoing situations. It is therefore the first object of the present invention to provide an LED lamp in which, because the lamp has therein a heat dissipation transfer member and the power source base thereof is made of materials including polycarbonate, etc. with a high emission rate of radiation so as to enhance its surface heat dissipation constant, the power source base has sufficient heat dissipation performance and thus, a separate insulation circuit is not necessary, thereby improving the reliability and productivity of the lamp as well as reducing the cost of manufacturing.

It is the second object of the present invention to provide an LED lamp, which provides uniform high-quality illuminance without glare by employing a light guiding type floodlight cover so that light from the LED is emitted uniformly over the entire outer surface including the peripheral region of the lamp.

It is the third object of the present invention to provide an LED lamp, which can improve the heat dissipation performance markedly using a vertical ventilation channel, which produces a stack effect by the temperature difference between air at normal temperature flowing from the lower external space to the lamp and upward-moving air heated through exchanging heat with the PCB within the lamp.

It is the fourth object of the present invention to provide an LED lamp, which includes a power control unit integrating an optical source part in which both the power control unit and LEDs (light source) are mounted onto one PCB and, hence, reducing PCB equipment expense by about a half and raising the productivity of the lamp remarkably.

### Solutions for Problems

The first object is achieved by the provision of an LED lamp comprising one or more LEDs mounted on a PCB, a floodlight cover that transmits light from the LEDs, and a power source base coupled to the floodlight cover and having a terminal at one end thereof, wherein the power source base is made of an insulation material; and the LED lamp also comprises a heat dissipation transfer member that has a heat sink in contact with the PCB on which the LEDs are mounted, and has a main body formed and installed so as to overlap with and be in tight contact with the inner side of either the power source base or the floodlight cover or both.

The second object is achieved by the provision of an LED lamp comprising one or more LEDs mounted on a PCB, a floodlight cover that transmits light from the LEDs, and a power source base coupled to the floodlight cover and having a terminal at one end thereof, wherein the floodlight cover is formed as a cover type having an inner space; the cover comprises a light guiding type floodlight cover and a light receiving means; the light guiding type floodlight cover guides and diffuses light toward the entire outer face thereof; the light receiving means receiving light from the LEDs is formed at a tip end of the body of the light guiding type floodlight cover at which the light guiding type floodlight cover is coupled to the power source base; and a reflection member is formed on the inner side wall of the light guiding type floodlight cover.

The third object is achieved by the provision of an LED lamp comprising one or more LEDs mounted on a PCB, a floodlight cover that transmits light from the LEDs, and a power source base coupled to the floodlight cover and having a terminal at one end thereof, wherein at least one ventilation opening is formed in and penetrates through at least one of the base, the cover, the heat dissipation member, the reflection member and the PCB so that a ventilation channel for heat dissipation is formed, which penetrates from outside the lamp through the base and runs via the inner space of the lamp and penetrates through the cover to communicate with the outside.

The fourth object is achieved by the provision of an LED lamp comprising one or more LEDs mounted on a PCB, a floodlight cover that transmits light from the LEDs, and a power source base coupled to the floodlight cover and having a terminal at one end thereof, wherein a power control unit integrating an optical source part is formed in which both the LEDs (light source) and the power control unit for driving the LEDs are mounted on one PCB.

### Effects of the Invention

The present invention has the following effects:

First, the lamp has therein a heat dissipation transfer member so that heat generated from the LEDs while the LEDs are on can be diffused and transferred rapidly to the entire area of the power source base or the floodlight cover, and the power source base is made of materials including polycarbonate, etc with a high emission rate of radiation so as to enhance its surface heat dissipation constant. In this manner, the power source base has sufficient heat dissipation performance even though it is made of an insulation material and, hence, a separate insulation circuit is not necessary, which improves the reliability and productivity of the lamp and reduces the cost of manufacturing.

Second, as the light guiding type floodlight cover guides and diffuses light from the LED lamp so as to emit the light uniformly over the entire outer surface including the peripheral region of the lamp, the lamp can provide uniform illuminance over the entire region and high brightness without glare, thereby improving the quality of illumination remarkably.

Third, the lamp includes a vertical ventilation channel for heat dissipation, which produces a stack effect by the temperature difference between air at normal temperature flowing from the lower external space to the lamp and upward-moving air heated through exchanging heat with the PCB within the lamp, and consequent difference in lifting power and pressure. By the stack effect, warm air within the lamp rises rapidly and is discharged out of the lamp, and accordingly, the heat dissipation performance is improved markedly.

Fourth, as the lamp employs a power control unit integrating an optical source part in which both the power control unit and LEDs (light source) are mounted onto the same PCB, the expense of PCB equipment is reduced by about a half and, furthermore, a connector and the connecting process are not necessary, thereby reducing the cost of manufacturing markedly and minimizing defects.

### BRIEF DESCRIPTION OF THE DRAWINGS

Other objects and advantages of the present invention will become apparent from the following description of exemplary embodiments with reference to the accompanying drawings in which:

FIG. 1 shows a cross-sectional view of disassembled parts of an LED lamp according to one exemplary embodiment of the present invention;

FIG. 2 shows a cross-sectional view of the assembled LED lamp of FIG. 1;

FIG. 3 shows a cross-sectional view of an assembled LED lamp according to one exemplary embodiment of the present invention;

FIG. 4 shows a plan view of a cross section taken at line A-A of FIG. 3;

FIG. 5 shows a cross-sectional view of an assembled LED lamp according to one exemplary embodiment of the present invention;

FIG. 6 shows a plan view of a cross section taken at line B-B of FIG. 5;

FIG. 7 shows a cross-sectional view of an assembled LED lamp according to one exemplary embodiment of the present invention;

FIG. 8 shows a cross-sectional view of a light guiding type floodlight cover according to one exemplary embodiment of the present invention;

FIG. 9 shows a cross-sectional view of a light guiding type floodlight cover according to one exemplary embodiment of the present invention;

FIG. 10 shows a plan view of a cross section taken at a line C-C of FIG. 9;

FIG. 11 shows a cross-sectional view of an assembled LED lamp according to one exemplary embodiment of the present invention;

FIG. 12 shows a perspective view of a heat dissipation transfer member according to one exemplary embodiment of the present invention;

FIG. 13 illustrates the reflection, refraction and total internal reflection of light;

FIG. 14 shows a cross-sectional view of an assembled LED lamp according to one exemplary embodiment of the present invention; and

FIG. 15 shows a cross-sectional view of an assembled LED lamp according to one exemplary embodiment of the present invention.

### DETAILED DESCRIPTION OF PREFERRED EXEMPLARY EMBODIMENTS

Exemplary embodiments of the present invention will be described with reference to the accompanying drawings.

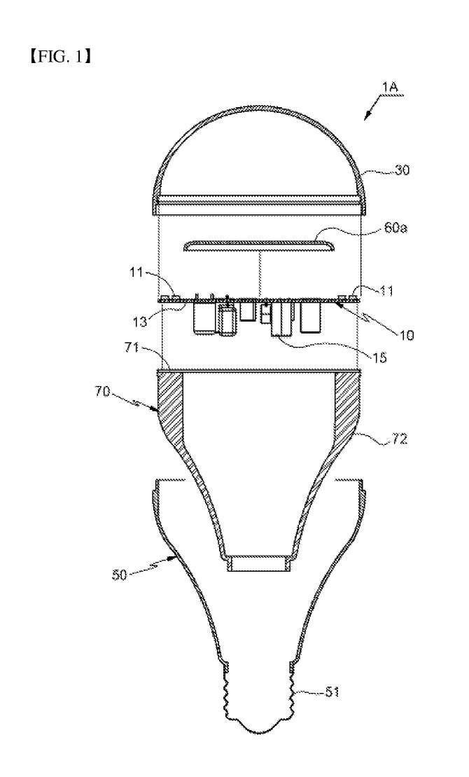

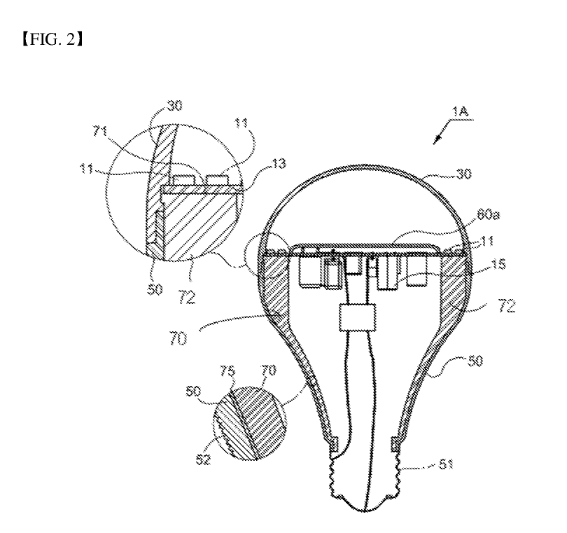

FIG. 1 shows a cross-sectional view of the disassembled parts of an LED lamp according to one exemplary embodiment of the present invention, and FIG. 2 shows a cross-sectional view of the assembled LED lamp of FIG. 1.

As shown in FIG. 1 and FIG. 2, LED lamp 1A according to the first exemplary embodiment of the present invention comprises one or more LEDs 11 mounted on the PCB 13, a floodlight cover 30 that transmits light from the LEDs 11, and a power source base 50 coupled to the floodlight cover 30 and having a terminal 51 at one end thereof. The power source base 50 is made of an insulation material, and lamp 1A further comprises a heat dissipation transfer member 70 which includes a heat sink 71 and a main body 72 formed and installed so as to overlap with and be in tight contact with the inner side of either the power source base 50 or the floodlight cover or both 30.

Here, the heat dissipation transfer member 70 may be adhered to the inner face of either the power source base 50 or the floodlight cover 30 or both via a heat-transmissive thermal adhesive means 75; or the heat dissipation transfer member 70 may be inserted during the injection molding of the power source base 50.

The thermal adhesive means 75 may include thermal grease or an elastic thermal pad.

In case that the heat dissipation transfer member 70 is inserted into the power source base 50 and, then, the injection molding of the power source base 50 is performed, the heat dissipation transfer member 70 is in tight contact with the power source base 50 so that the heat exchange between the power source base 50 and the member 70 is maximized. Here, the heat dissipation transfer member 70 may be made of aluminum with high thermal conductivity.

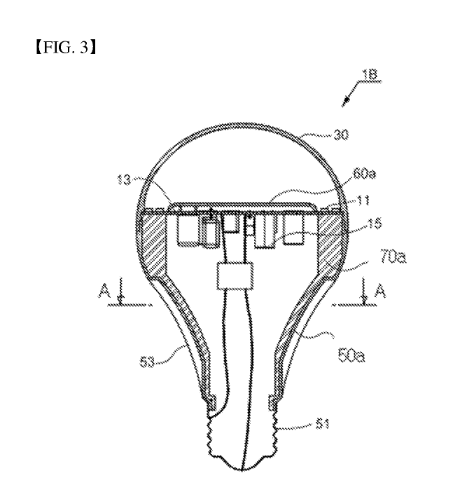

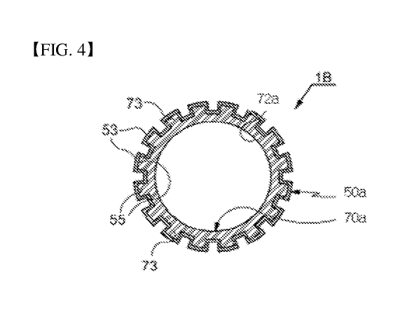

In LED lamp 1B according to the second exemplary embodiment of the present invention, the heat dissipation area is enlarged through forming at least one of a micro concave-convex 52 including a sanding concave-convex (refer to FIG. 2), ceramic coating, and heat dissipation fins 53 (refer to FIG. 3 and FIG. 4) protruding radially on the outer peripheral face of the power source base 50.

Here, the ceramic coating is advantageous not only in that micro concave-convex is formed naturally but also in that it has a high emission rate of radiation (refer to Table 1).

In the third exemplary embodiment 1B according to the present invention, as shown in FIG. 3 and FIG. 4, heat dissipation fins 53 are formed in the shape of ribs, protruding radially on the outer peripheral face of a power source base 50a, and at the same time the interior of a portion of the base 53 from which the heat dissipation fins 53 protrude is formed as a recess 55; and a the heat dissipation transfer member 70a has heat transfer fins 73 which protrude so as to be inserted into and be engaged with the recess 55 of the power source base 50.

In the configuration of the third exemplary embodiment 1B, the heat transfer area between the power source base 50a and the heat dissipation transfer member 70a as well as the heat dissipation area of the power source base 50a can be enlarged by forming a radially protruding coupling face between the power source base 50a and the heat dissipation transfer member 70a.

Moreover, the power source base 50a is formed as thin as possible in order to improve the heat dissipation efficiency.

The power source base 50a may be made of polycarbonate, etc with a high-emission rate of radiation (refer to FIG. 1). The terminal 51 may be of different forms like a receptacle that is a power supply connecting terminal coupled to an external power supply unit in a screw coupling manner, or a pin type terminal used in a halogen lamp.

TABLE 1
Thermal properties of primary materials

| | Emission rate | Thermal conductivity |
|---|---|---|
| Material | of radiation | (W/mK) |
| Aluminum | 0.02-0.2 | 204 |
| Brass | 0.02-0.22 | 111 |
| Copper | 0.02-0.05 | 386 |
| Iron | 0.06-0.3 | 73 |
| Nickel | 0.07-0.5 | 90 |
| Chrome | 0.08-0.26 | 16 |
| Carbon (graphite) | 0.7-0.95 | 1.7 |
| Ceramic | 0.5-0.95 | 0.5-40 |
| Polycarbonate | 0.9-0.98 | 0.19-0.22 |

Now, how the first to third exemplary embodiments of the present invention having such configurations operate will be explained.

Regarding the first exemplary embodiment 1A of the present invention, in an LED lamp in which the LEDs 11 are installed within the inner space formed through the coupling of the floodlight cover 30 and the power source base 50 made of an insulation material and, hence, heat generated from the LEDs 11 does not dissipate well, the heat sink 71 is formed so as to be in contact with the PCB 13 on which the heat-generating LEDs are mounted and, furthermore, the heat dissipation transfer member 70 has its main body 72 being in tight contact with the large inner face of the power source base 50 or the floodlight cover 30 so that heat from the PCB 13 is diffused and transferred directly to the large area of the floodlight cover 30 or the power source base 50 which, in turn, radiates and emits the heat to the outside.

In other words, heat generated from the PCB while the LEDs are on sinks toward the heat sink 71 and is transferred and diffused rapidly to the entire large area of the main body 72 of the heat dissipation transfer member 70 made of a material with high thermal conductivity and, next, the heat is diffused and transferred rapidly to the entire area of the power source base 50 or the floodlight cover 30 because that a large area of the main body 72 of the heat dissipation transfer member 70 overlaps with and is in tightly contact with the inner face of the power source base 50 or the floodlight cover 30.

Thereafter, the heat is transferred from the inner face of the power source base 50 formed as thin as possible and made of a polycarbonate with a high emission rate of radiation or the floodlight cover 30 to the outer surface of the power source base 50 and, hence, the heat radiates and is emitted over a large surface area, resulting in efficient heat dissipation.

In addition to this, as in the second exemplary embodiment, micro concave-convex 52, ceramic coating, or heat dissipation fins 53 are formed on the outer surface of the power source base 50 or 50a so as to protrude from the power source base, resulting in enlarging the heat dissipation area further.

Moreover, as in the third exemplary embodiment, as the interior of a portion of the base 53 from which the heat dissipation fins 53 protrude is formed as recesses 55, and heat transfer fins 73 corresponding to the recesses 55 are formed on the heat dissipation transfer member 70a having a main body 72a, the heat transfer area as well as the heat dissipation area can be enlarged further, resulting in increasing the surface heat dissipation constant and, thus, improving the heat dissipation performance remarkably (refer to FIG. 3 and FIG. 4).

In case the power source base is made of aluminum with non-insulation property, the temperature difference between the inner face and the outer surface of the base becomes less than 1° C. due to the high thermal conductivity of the aluminum, but the emission rate of radiation thereof is very low.

In the present invention in which the power source base 50 is made of a polycarbonate with insulation property and is formed 1.2 mm thick, and the heat dissipation transfer member 70 is in tight contact with the power source base 50 via thermal grease, the temperature difference between the inner face and the outer surface of the power source base 50 in turning-on the lamp becomes 8° C.

However, in case heat dissipation fins 53, recesses 55 and heat transfer fins 73 are formed and, at the same time, the heat dissipation transfer member 70a is inserted into the power source base 50a during the injection molding of the power source base 50a, the temperature difference becomes 4° C. The temperature difference can be overcome by the superior emission rate of radiation of the polycarbonate.

In this way, as the heat dissipation transfer member 70 or 70a is formed in tight contact with the inner face of the power source base 50 or 50a or the floodlight cover 30, and the outer surface area of the power source base 50 or 50a and the heat transfer area between the power source base 50 or 50a and the heat dissipation transfer member 70 or 70a are maximized, heat generated from the LEDs can be diffused and transferred rapidly to the entire area of the power source base 50 or 50a or the floodlight cover 30. Furthermore, as the power source base 50 or 50a is made of polycarbonate with a high emission rate of radiation, the heat dissipation efficiency and performance can be enhanced further.

As a result, the power source base 50 made of an insulation material dissipates heat efficiently and, thus, makes an insulation circuit unnecessary.

In other words, the present invention enables the power source base made of an insulation material to dissipate heat efficiently and consequently to exclude an insulation circuit from the LED lamp, thereby simplifying the circuit configuration of the power control unit 15 and, thus, improving the reliability of the lamp and facilitating the manufacturing of the lamp.

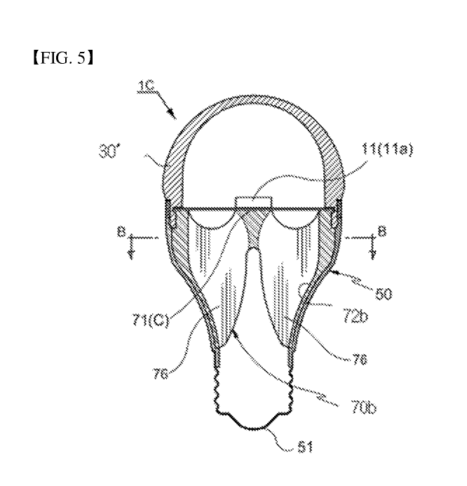

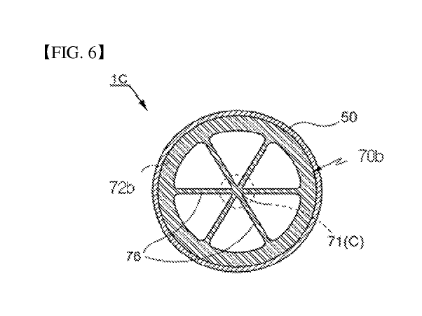

In the fourth exemplary embodiment 1C according to the present invention, as shown in FIG. 5 and FIG. 6, the heat sink 71 of a heat dissipation transfer member 70b is formed in either the peripheral region or the central region C of the lamp; and heat transfer wings 76, which connect the heat sink 71 formed in the central region C and a the main body 72b of the heat dissipation transfer member 70b with each other, is formed radially in the shape of ribs. In FIG. 5, reference number ‘30′’ refers to a floodlight cover.

The configuration in which the heat sink 71 is formed in the central region C is required when the LEDs 11 are embedded in the central region of the lamp. In such a configuration, AC LEDs 11a may be employed as the LEDs 11.

In this fourth exemplary embodiment 1C in which LEDs 11 including AC LEDs 11a are embedded in the central region of the lamp, the heat sink 71 is formed in the central region, and heat transfer wings 76 are formed radially in the shape of ribs for transferring the heat rapidly from the heat sink 71 to the main body 72b of the heat dissipation transfer member 70b. As a result, the heat can be transferred rapidly through the main body 72b to the entire area of the power source base 50, resulting in efficient heat dissipation.

In the fifth exemplary embodiment according to the present invention, as shown in FIG. 1 to FIG. 3, the LEDs 11 are mounted on the outer region of the PCB 13 so as to surround the outer region, and a reflection cap 60a is formed above the PCB 13 where the LEDs 11 are not positioned.

The reflection cap 60a is fixed to the PCB 13 upside down and reflects the light moving toward the inner space of the lamp.

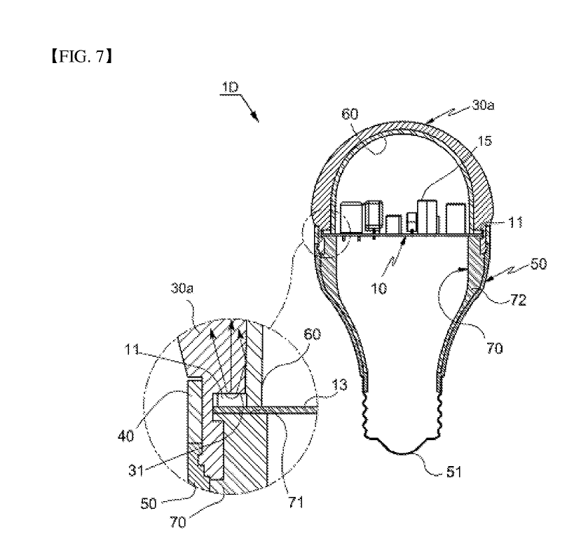

In the sixth exemplary embodiment 1D according to the present invention, as shown in FIG. 7, the LED lamp comprises one or more LEDs 11 mounted on a PCB 13, a floodlight cover 30a that transmits light from the LEDs 11, and a power source base 50 coupled to the floodlight cover 30a and having a terminal 51 at one end thereof, wherein the floodlight cover 30a is formed as a cover type having an inner space; the floodlight cover 30a comprises a light guiding type floodlight cover 30a and a light receiving means 31; the light guiding type floodlight cover 30a guides and diffuses the light toward the entire outer face thereof; the light receiving means 31 receiving light from the LEDs 11 is formed at a tip end of the body of the light guiding type floodlight cover 30a at which the light guiding type floodlight cover 30a is coupled to the power source base 50; and a reflection member 60 is formed on the inner side wall of the light guiding type floodlight cover 30a.

Here, the reflection member 60 is formed so as to be in tight contact with the light guiding type floodlight cover 30a.

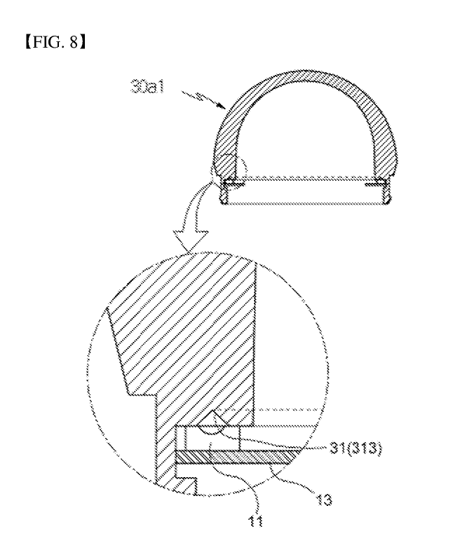

Moreover, as shown in FIG. 8 to FIG. 10, at least one of a lens 313, scratches 311 and a micro concave-convex including a sanding concave-convex is formed in the light receiving means 31 in order to diffuse the received light.

The lens 313 may be formed in various ways, for example, as a sequence of V grooves (refer to FIG. 8) or as a semi-circular recess (not shown) corresponding to each of a plurality of LEDs 11.

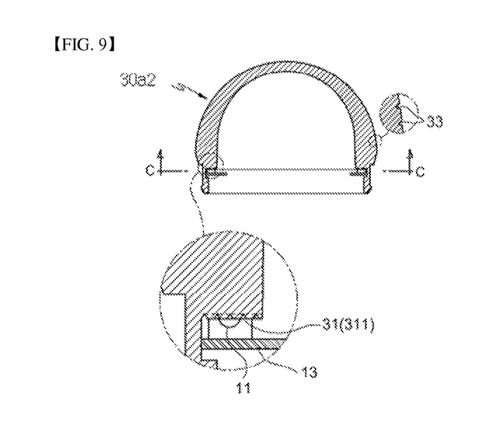

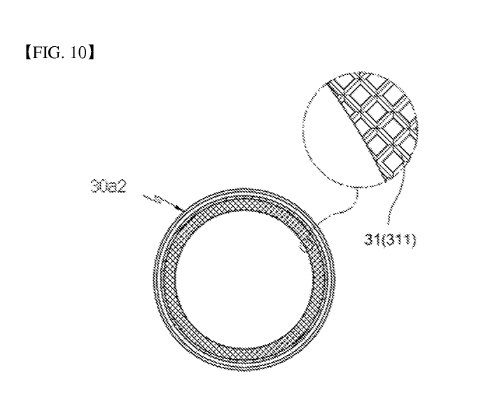

Moreover, the scratches 311 may be made in various forms including the shape of saw teeth in the cross-sectional view, and the shape of matrix in the bottom view in which lines grooved of V shape intersect one another at a right angle (refer to FIG. 9 and FIG. 10).

Moreover, as shown in FIG. 9, at least one of scratches 33, a micro concave-convex including a sanding concave-convex, and printed dots is formed on at least either the inner or outer surface of the body of a light guiding type floodlight cover 30a2 in order to diffuse the light uniformly.

The floodlight cover 30 including the light guiding type floodlight cover 30a may be made of acrylic.

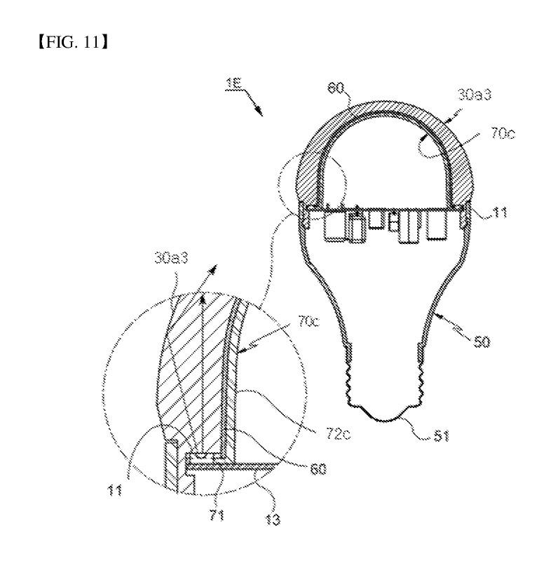

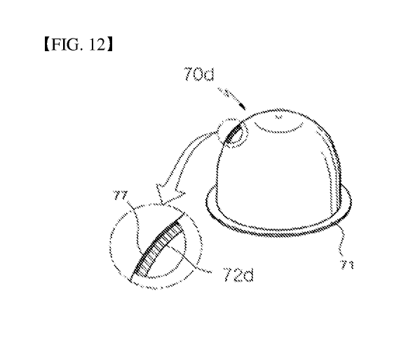

In the seventh exemplary embodiment 1E according to the present invention, as shown in FIG. 11, the floodlight cover consists essentially of a light guiding type floodlight cover 30a3; and a reflection member 60 and a heat dissipation transfer member 70c having a main body 72c are formed sequentially on the inner side wall of the light guiding type floodlight cover 30a3 so as to be in tight contact with the inner side wall; or as shown in FIG. 12, a heat dissipation transfer member 70d having a main body 72d on which a reflection layer 77 is coated is formed on and is in tight contact with the outer surface of the light guiding type floodlight cover 30a3.

Moreover, in case the heat dissipation transfer member 70d on which a reflection layer 77 is coated is formed on the outer surface of the light guiding type floodlight cover 30a3, the heat dissipation transfer member 70d also serves as a reflection member, resulting in simplifying the entire configuration of the lamp.

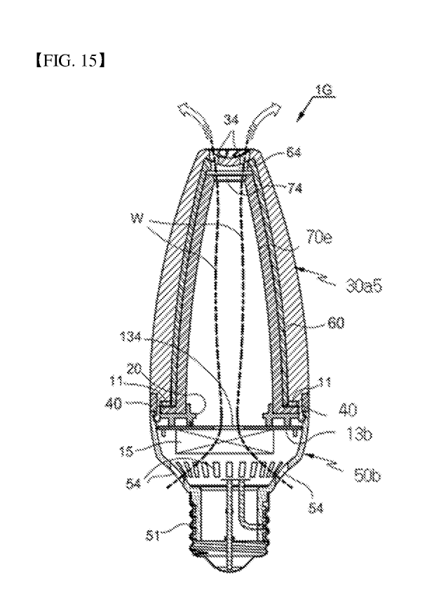

As shown in FIG. 15, an elastic supporting member 20 is formed between a heat dissipation transfer member 70e and one of a power source base 50b, a light guiding type floodlight cover 30a5 and the PCB 13b in order to keep the heat dissipation transfer member 70e being in tight contact with the light guiding type floodlight cover 30a5.

One side of the elastic supporting member 20 is supported by the power source base 50b, the light guiding type floodlight cover 30a5 or the PCB 13b, while the other side of the elastic supporting member 20 applies elastic pressure to the heat dissipation transfer member 70e, so that the elastic supporting member 20 keeps the heat dissipation transfer member 70e being in tight contact with the light guiding type floodlight cover 30a5.

Now, how the sixth exemplary embodiment 1D and the seventh exemplary embodiment 1E of the present invention having such configurations operate will be explained.

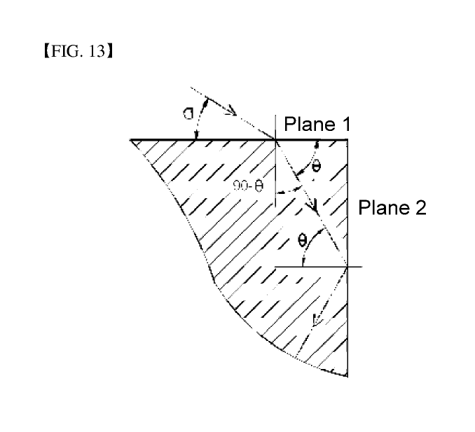

Looking over the light refraction characteristics of acrylic of which the light guiding type floodlight cover 30a or 30a3 is made with reference to FIG. 13, the light refractive index (n) of acrylic is 1.49, the total reflection angle (θc) of acrylic is theoretically calculated to be 42.155° and the condition for total internal reflection is θ>θc. That is, total internal reflection occurs if refractive angel θ is larger than 42.155°.

In FIG. 13, provided that the incident angle is α, the refraction law in “Plane 1” is as follows:

sin(90−α)=n sin(90−θ)→cos α=n cos θ→θ=cos⁻¹(1/n*cos θ)

In the above equation, refractive angle θ is in a range of 47.84°≦θ≦90° according to 0°≦α≦90°.

Therefore, the condition for total internal reflection i.e. θ>θc is always satisfied. Accordingly, in case the light guiding type floodlight cover 30a or 30a3 is made of acrylic, total internal reflection always occurs as long as the planes are kept exactly flat, so that the incident light may not be emitted through “Plane 2”. However, if scratches are formed on the surface of the planes, the refractive angle becomes smaller, so that the incident light may emit through the scratches.

The light guiding type floodlight cover 30a, 30a1, 30a2, 30a3, 30a4 or 30a5 according to the present invention is characterized by the employment of such light refraction and total internal reflection characteristics.

That is, in the light guiding type floodlight cover 30a, 30a1, 30a2, 30a3, 30a4 or 30a5 made of acrylic, etc, light incoming from the LEDs 11 through the light receiving means 31 formed at the tip end of the light guiding type floodlight cover 30a, 30a1, 30a2, 30a3, 30a4 or 30a5 is guided and diffused along the thickness direction of the body thereof in the manner of total internal reflection and, then, is emitted through the outer surface.

Because the light guiding type floodlight cover 30a, 30a1, 30a2, 30a3, 30a4 or 30a5 is formed not of a flat board type but of a cover type so as to form an inner space therein, the quantity of light emission is small in the peripheral wall in which the angle between the wall and the light incoming and progressing from the LEDs is small. To solve this problem, as mentioned above, at least one of a lens 313, scratches 311 and a micro concave-convex including a sanding concave-convex is formed in the light receiving means 31, so that the angle at which the light incoming from the LEDs is directed to the light guiding type floodlight cover 30a, 30a1, 30a2, 30a3, 30a4 or 30a5 becomes larger and, hence, the quantity of light guided to the peripheral wall increases, resulting in improving the uniformity of light diffusion and illuminance remarkably.

In addition to this, when scratches 33 or sanding concaves-convexes are formed on the outer surface for emitting light, they maximize the uniformity of light diffusion.

Therefore, the light guiding type floodlight cover 30a, 30a1, 30a2, 30a3, 30a4 or 30a5 makes light emitted uniformly over the entire face including the peripheral wall. Furthermore, the reflection member 60 prevents light loss within the light guiding type floodlight cover 30a and improves the uniformity of illuminance.

Consequently, the lamp can provide uniform high-quality illuminance without glare as light from the LED lamp is emitted uniformly over the entire outer surface including the peripheral region thereof as well as the perpendicular region.

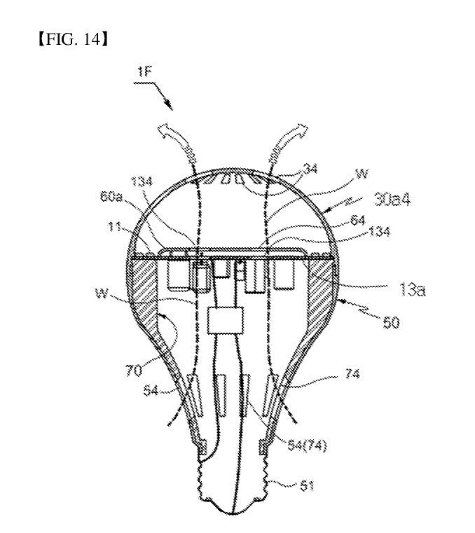

In the eighth exemplary embodiment of the present invention, at least one of ventilation openings 54, 34, 74, 64 and 134 is formed in at least one of the power source base 50 or 50b, the floodlight cover 30a5 or 30a6 the heat dissipation transfer member 70 or 70e, the reflection member 60 and the PCB 13a or 13b so that air communicates between the inner and outer spaces of the lamp (refer to FIG. 14 and FIG. 15).

In the ninth exemplary embodiment of the present invention, as shown in FIG. 14 and FIG. 15, at least one of ventilation openings 54, 34, 74, 64 and 134 is formed in and penetrates through at least one of the power source base 50 or 50b, the floodlight cover 30a4 or 30a5, the heat dissipation transfer member 70 or 70e, the reflection member 60 and the PCB 13a or 13b so that a ventilation channel W for heat dissipation is formed, which penetrates from the outside of the lamp through the power source base 50 or 50b and runs via the inner space of the lamp and penetrates through the floodlight cover 30a4 or 30a5 to communicate with the outside.

Different from the eighth exemplary embodiment of the present invention, which has one or more ventilation openings without a ventilation channel penetrating through the lamp, the ninth exemplary embodiment of the present invention has a ventilation channel penetrating through the lamp for heat dissipation, through which air flows upwards.

Looking over cases of the ninth exemplary embodiment of the present invention, the first case as shown in FIG. 14 is an LED lamp 1F in which a heat dissipation transfer member 70 is installed so as to overlap with the power source base 50. In the lamp, a floodlight cover 30a4 and a reflection cap 60a are formed, and one or more of the ventilation openings 54, 74, 134, 64 and 34 are formed in and penetrate through the power source base 50, the heat dissipation transfer member 70, PCB 13a, the reflection cap 60a and the floodlight cover 30a4 respectively so that a ventilation channel W for heat dissipation is formed, through which air flows upwards. The second case as shown in FIG. 15 is an LED lamp 1G in which a heat dissipation transfer member 70e is installed so as to overlap with the light guiding type floodlight cover 30a5. In the lamp, one or more of the ventilation openings 54, 134, 74, 64 and 34 are formed in and penetrate through the power source base 50b, PCB 13b, the heat dissipation transfer member 70, the reflection member 60 and the light guiding type floodlight cover 30a5 respectively so that a ventilation channel W for heat dissipation is formed, through which air flows upwards.

In the configuration of the ninth exemplary embodiment 1F, 1G of the present invention, the ventilation channel W for heat dissipation runs in the vertical direction so that external air flows through the ventilation opening 54 in the power source base 50 or 50b into the lamp and, then, runs via the internal space, and, subsequently, exchanges heat with the warm air from the LEDs while the LEDs are on, and, next, is discharged through the ventilation opening 34 in the floodlight cover 30a4 or 30a5 to the outside, resulting in producing a stack effect, and thus, improving the heat dissipation performance markedly.

That is, there occurs a stack effect by the temperature difference between air at normal temperature flowing through the ventilation opening 54 in the power source base 50 or 50b into the lamp and upward-moving air heated through exchanging heat with the PCB within the lamp, and consequent difference in lifting power and pressure. By the stack effect, warm air within the lamp rises rapidly and is discharged out of the floodlight cover 30a4 or 30a5, and accordingly, the heat dissipation performance is improved markedly.

In the tenth exemplary embodiment of the present invention, as shown in FIG. 1, etc., a power control unit integrating an optical source part 10 is formed in which LEDs 11 and a power control unit 15 for driving the LEDs 11 are mounted on one PCB 13.

In this way, as the power control unit 15 and LEDs (light source) 11 are mounted onto one PCB 13 and are integrated into one body and, hence, only one PCB is consumed while two PCBs are consumed in the prior-art technique, the cost of PCB equipment is reduced by about a half.

Furthermore, as a separate wire, a separate connector and a separate connecting process, which electrically interconnects the PCB for the optical source and the PCB for the power control unit, are not required, the cost of manufacturing is reduced remarkably and, at the same time, the productivity of the lamp is improved greatly.

Moreover, the exemplary embodiment of the present invention excludes defects that may otherwise occur in the connecting process.

On the other hand, in FIG. 7 and FIG. 15, reference number ‘40,’ which has not yet explained, refers to a decoration rim.

As mentioned above, the present invention has the following effects:

First, as the heat dissipation transfer member is formed in tight contact with the inner face of the power source base or the floodlight cover, and the outer surface area of the power source base and the heat transfer area between the power source base or the cover and the heat dissipation transfer member are maximized, heat generated from the LEDs can be diffused and transferred rapidly to the entire area of the power source base or the floodlight cover. At the same time, as the power source base is made of polycarbonate with a high emission rate of radiation, the power source base enhances the heat dissipation efficiency and, thus, a separate insulation circuit is not necessary, thereby improving the reliability of the lamp and reducing the cost of manufacturing.

Second, as the light guiding type floodlight cover guides and diffuses light from the LED lamp so as to emit the light uniformly over the entire outer surface including the peripheral region of the lamp, the lamp can provide uniform illuminance without glare over the entire region and high brightness without glare, thereby improving the quality of illumination remarkably.

Third, because the lamp includes a vertical ventilation channel for heat dissipation, which produces a stack effect by the temperature difference between air at normal temperature flowing through the ventilation opening in the power source base into the lamp upward-moving air heated through exchanging heat with the PCB within the lamp, and consequent difference in lifting power and pressure. By the stack effect, warm air within the lamp rises rapidly and is discharged out of the lamp, and accordingly, the heat dissipation performance is improved markedly.

Fourth, as the lamp employs a power control unit integrating an optical source part in which both the power control unit and LEDs (light source) are mounted onto the same PCB, the expense of PCB equipment is reduced by about a half and, furthermore, a connector and the connecting process are not necessary, thereby reducing the cost of manufacturing markedly and minimizing defects.

Although the present invention has been described and illustrated in detail, it is clearly understood that the same is by way of illustration and example only and is not to be taken by way of limitation, the spirit and scope of the present invention being limited only by the terms of the appended claims.

### LISTS OF THE COMPONENTS

1A, 1B, 1C, 1D, 1E, 1F, 1G: LED lamp
11: LEDs
13: PCB
15: power control unit
30: floodlight cover
30a: light guiding type floodlight cover
31: light receiving means
313: lens
50: power source base
51: terminal
53: heat dissipation fin
54: ventilation opening
55: recess
60: reflection member
60a: reflection cap
70, 70a: heat dissipation transfer member
71: heat sink
72: main body of heat dissipation transfer member
73: heat transfer fin
74: ventilation opening
75: thermal adhesive means
76: heat transfer wing
77: reflection coating layer
W: ventilation channel for heat dissipation

1. An LED lamp comprising:
at least one LED mounted on a PCB;
a floodlight cover for transmitting light from the at least one LED, wherein the floodlight cover has an inner face facing an upper inner space of the LED lamp;
a power source base coupled to a terminal at one end of the power source base and coupled to the floodlight cover at the other end of the power source base, wherein the power source base is made of an insulation material and forms a surface layer of the LED lamp from the one end of the power source base to the other end of the power source base, and wherein the power source base has an inner face facing a lower inner space of the LED lamp; and
a heat dissipation transfer member having a heat sink being in contact with the PCB, and a main body formed along with an entire surface of at least one of the inner face of the power source base and the inner face of the floodlight cover, wherein the main body of the heat dissipation transfer member is faced with the entire surface without any space therebetween.

2. The LED lamp of claim 1, wherein the heat dissipation transfer member is coupled to at lease one of the inner face of the power source base and the inner face of the floodlight cover via a heat-transmissive thermal adhesive means, or is inserted into the power source base.

3. The LED lamp of claim 1, wherein the power source base has an outer peripheral face on which at least one of a micro concave-convex, ceramic coating, and heat dissipation fins is formed.

4. The LED lamp of claim 1, wherein an outer peripheral face of the power source base includes heat dissipation fins formed in the shape of ribs and protruding radially therefrom, and the inner face of the power source base includes recesses; and
wherein the heat dissipation transfer member has heat transfer fins that protrude into the recesses of the power source base.

5. The LED lamp of claim 1, wherein the heat sink of the heat dissipation transfer member is formed in a central region of the LED lamp; and
wherein heat transfer wings connect the heat sink formed in the central region and the main body of the heat dissipation transfer member to each other, the heat transfer wings being formed radially in the shape of ribs.

6. The LED lamp of claim 1, wherein the at least one LED is mounted in an outer periphery of the PCB, and a reflection cap is formed above the PCB and in a region where the at least one LED is not positioned.

7. The LED lamp of claim 1, wherein the floodlight cover is formed as a cover type having an inner space therein;
wherein the floodlight cover comprises a light guiding floodlight cover and a light receiving means;
wherein the light guiding floodlight cover guides and diffuses the light toward the entire outer face thereof;
wherein the light receiving means receiving light from the at least one LED is formed at a tip end of a body of the light guiding floodlight cover at which the light guiding floodlight cover is coupled to the power source base; and
wherein a reflection member is formed on an inner side wall of the light guiding floodlight cover.

8. The LED lamp of claim 7, wherein at least one of a lens, scratches and a micro concave-convex is formed in the light receiving means in order to diffuse the received light.

9. The LED lamp of claim 7, wherein at least one of scratches, a micro concave-convex and printed dots is formed in at least one of an inner surface and an outer surface of the body of the light guiding floodlight cover in order to diffuse the light uniformly.

10. The LED lamp of claim 1, wherein the floodlight cover consists essentially of a light guiding floodlight cover; and
wherein a reflection member and the heat dissipation transfer member are formed sequentially on an inner side wall of the light guiding floodlight cover so as to be in tight contact with the inner side wall of the light guiding floodlight cover.

11. The LED lamp of claim 10, wherein an elastic supporting member is formed between the heat dissipation transfer member and one of the power source base, the light guiding floodlight cover and the PCB in order to keep the heat dissipation transfer member being in tight contact with the light guiding floodlight cover.

12. The LED lamp of claim 1, wherein at least one of ventilation openings is formed in at least one of the power source base, the floodlight cover, the heat dissipation transfer member and the PCB so that air communicates between an inner space and an outer space of the LED lamp.

13. The LED lamp of claim 1, wherein at least one of ventilation openings is formed in and penetrates through at least one of the power source base, the floodlight cover, the heat dissipation transfer member and the PCB installed within the LED lamp so that a ventilation channel for heat dissipation is formed, the ventilation channel penetrating from an outside of the LED lamp via the power source base, an inner space of the LED lamp and the floodlight cover to the outside of the LED lamp.

14. The LED lamp of claim 1, further comprising an optical source part in which the at least one LED and a power control unit for driving the at least one LED are mounted on the PCB.

15. The LED lamp of claim 2, wherein an outer peripheral face of the power source base includes heat dissipation fins formed in the shape of ribs and protruding radially therefrom, and the inner face of the power source base includes recesses; and
wherein the heat dissipation transfer member has heat transfer fins that protrude into the recesses of the power source base.

16. The LED lamp of claim 3, wherein an outer peripheral face of the power source base includes heat dissipation fins formed in the shape of ribs and protruding radially therefrom, and the inner face of the power source base includes recesses; and
wherein the heat dissipation transfer member has heat transfer fins that protrude into the recesses of the power source base.

17. The LED lamp of claim 1, wherein the floodlight cover consists essentially of a light guiding floodlight cover; and
wherein the heat dissipation transfer member on which a reflection layer is coated is formed on an inner surface of the light guiding floodlight cover, and the heat dissipation transfer member is in tight contact with the inner face of the light guiding floodlight cover.

18. The LED lamp of claim 7, wherein at least one of ventilation openings is formed in at least one of the power source base, the floodlight cover, the heat dissipation transfer member, the reflection member and the PCB so that air communicates between an inner space and an outer space of the LED lamp.

19. The LED lamp of claim 7, wherein at least one of ventilation openings is formed in and penetrates through at least one of the power source base, the floodlight cover, the heat dissipation transfer member, the reflection member and the PCB installed within the LED lamp so that a ventilation channel for heat dissipation is formed, the ventilation channel penetrating from an outside of the LED lamp via the power source base, an inner space of the LED lamp and the floodlight cover to the outside of the LED lamp.

20. The LED lamp of claim 7, further comprising an optical source part in which the at least one LED and a power control unit for driving the at least one LED are mounted on the PCB.
